(19) United States
(12) Patent Application Publication
(10) Pub. No.: US 2017/0353791 A1
(43) Pub. Date: Dec. 7, 2017

(54) Identification Method of Nonlinear System of Loudspeaker

(71) Applicant: AAC Technologies Pte, Ltd., Singapore city (SG)

(72) Inventors: Yuxiang Hu, Shenzhen (CN); Jing Lu, Shenzhen (CN); Henglizi Zhang, Shenzhen (CN)

(21) Appl. No.: 15/587,536

(22) Filed: May 5, 2017

(30) Foreign Application Priority Data
Jun. 7, 2016 (CN) 201610399274.1

(51) Int. Cl. H04R 3/00; H04R 29/00; G01H 11/06

(52) U.S. Cl. CPC H04R 3/007; G01H 11/06; H04R 29/001

(57) ABSTRACT

An identification method of nonlinear system of loudspeaker includes the following steps: providing an amplified pumping signal to the loudspeaker; measuring a voltage signal and a current signal; obtaining linear parameters of the loudspeaker system; obtaining the nonlinear parameters of the loudspeaker system: inputting the measured current signal into a lumped parameter model of the loudspeaker system to calculate the estimated voltage signal; comparing the estimated voltage signal with the measured voltage signal to calculate a voltage error signal between the two; conducting decoherence with the voltage error signal to get rid of a linear component of the voltage error signal, obtaining then, according to the voltage error signal after decoherence, the nonlinear parameters by using an adaptive iterative algorithm.

### CROSS-REFERENCE TO RELATED APPLICATIONS

This application claims the priority benefit of Chinese Patent Application Ser. No. 201610399274.1 filed on Jun. 7, 2016, the entire content of which is incorporated herein by reference.

### FIELD OF THE PRESENT DISCLOSURE

The present disclosure relates to a method of measuring the parameters of a loudspeaker, in particular to a method of identifying the nonlinear system of a loudspeaker.

### DESCRIPTION OF RELATED ART

A micro loudspeaker has the advantage of small size, and it is therefore widely used in electronic equipment like intelligent mobile phones and tablet computers. But as the size decreases, the nonlinear of loudspeaker systems becomes more and more significant, under large signal conditions, the sounds of micro loudspeaker will show significant distortion. The establishment of a nonlinear model of micro loudspeaker systems, and the accurate estimation of the linear and nonlinear parameters of the micro loudspeaker systems under large signal conditions, and thus then the prediction and compensation of the nonlinear distortion of the loudspeaker systems attract more and more attention day by day.

Related technologies have disclosed a method to measure loudspeaker parameters with a current sensor and another with a laser sensor, the mentioned methods use the dual frequency pumping signals and the large signal Volterra model, when the order of the nonlinear of a loudspeaker system is relatively high (higher than 3), the complexity of the Volterra model increases significantly, and the flexibility is poor.

Therefore, an improved identification method of nonlinear system of a loudspeaker to overcome the above mentioned disadvantages is accordingly desired.

### BRIEF DESCRIPTION OF THE DRAWING

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is a schematic block diagram of an identification method of a loudspeaker's nonlinear system in accordance with an exemplary embodiment of the present disclosure;

FIG. 2 is a workflow chart of the identification method in accordance with the exemplary embodiment;

FIG. 3 is a voltage model corresponding to the lumped parameter model of the loudspeaker's system;

FIG. 4 is a mechanical model corresponding to the lumped parameter model of the loudspeaker's system;

FIG. 5 is an impedance curve measured by using the identification method and a matched impedance as well as an impedance amplitude-frequency curve;

FIG. 6 is an impedance curve measured by using the identification method and a matched impedance as well as an impedance phase frequency curve;

FIG. 7 is a nonlinear parameter curve and a BI-displacement curve estimated by the identification method;

FIG. 8 is a nonlinear parameter curve and a kt-displacement curve estimated by the identification method;

FIG. 9 is a nonlinear parameter curve and a Rm-velocity curve estimated by the identification method;

FIG. 10 is a sound pressure THD actually measured by the identification method and a sound pressure THD curve emulated by using estimation parameters.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

The invention will be further described below with reference to the accompanying drawings and embodiment. In the disclosure, uₘ[n] represents the measured voltage signal, iₘ[n] represents the measured current signal, uₚ[n] represents the estimated voltage signal calculated by using the loudspeaker voltage model, eᵤ[n] represents the voltage error signal between the estimated voltage signal eᵤ[n] and the measured voltage signal uₘ[n], eₙ[n] represents the voltage error signal after decoherence obtained after the decoherence operation on the voltage error signal.

The linear parameters identified by the nonlinear system of the loudspeaker include: DC resistance Rₑ, voice coil inductance Lₑ, force factor linear item b₀, stiffness factor linear item k₀ and mechanical resistance linear item r₀. The nonlinear parameters identified by the nonlinear system of the loudspeaker include: factor Bl(x), stiffness factor kₜ(x) and mechanical resistance Rₘ(v), wherein:

$$Bl ( x ) = {\sum }_{j = 0}^{N} {b}_{j} {x}^{j} \\ {k}_{t} ( x ) = {\sum }_{j = 0}^{N} {k}_{j} {x}^{j} \\ {R}_{m} ( v ) = {\sum }_{j = 1}^{N} {r}_{j} {v}^{j} \qquad ( 13 )$$

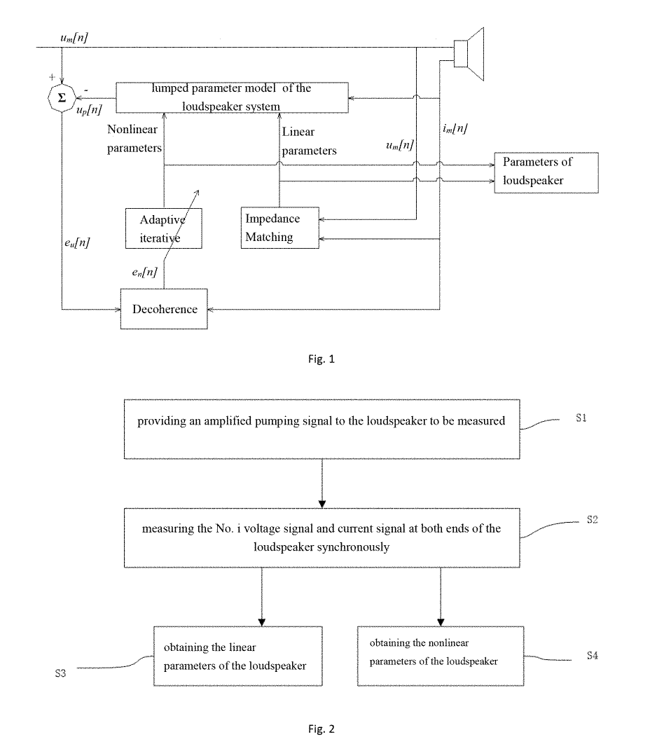

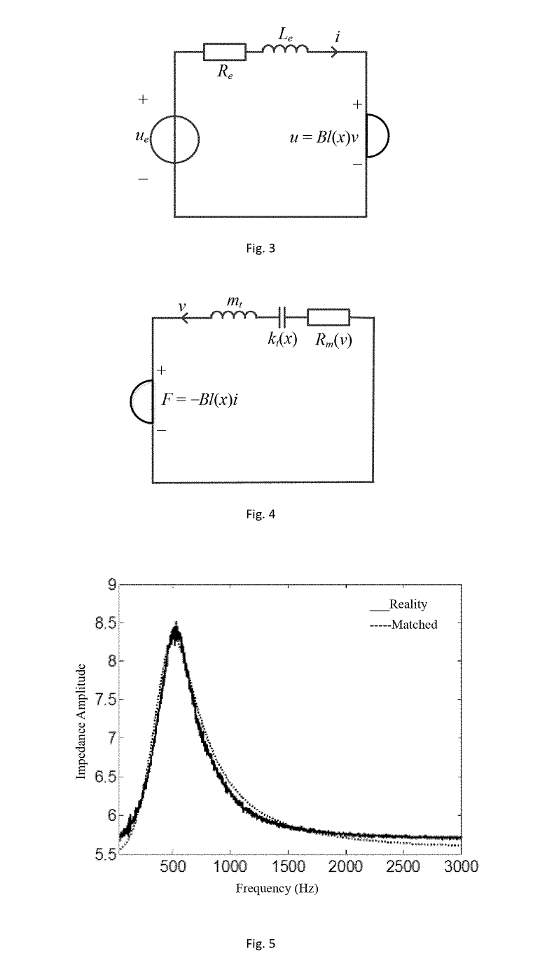

Referring to FIGS. 1-4, the identification method of a loudspeaker's nonlinear system according to the present disclosure includes the following steps:

S1: an external computer provides a pumping signal, which will be amplified by a power amplifier, and then the amplified pumping signal will be input into the loudspeaker system to be measured;

S2: a current sensor and a voltage sensor will be used to measure the voltage signal uₘ[n] and current signal iₘ[n] at both ends of the loudspeaker system synchronously, the voltage model it corresponds to can be expressed as:

$${u}_{e} = {R}_{e} i + Bl ( x ) v + {L}_{e} \frac{di}{dt} \qquad ( 1 )$$

The mechanical model it corresponds to can be expressed as:

Bl(x)i=mₜa+Rₘ(v)v+kₜ(x)x (2)

wherein, uₑ represents the pumping voltage of the loudspeaker, i represents the current in the loudspeaker, mₜ represents the equivalent vibration mass, and a represents the diaphragm acceleration.

S3: Obtaining the linear parameters:

Calculating, according to the measured voltage signal and measured current signal, under the condition of large signal, the impedance curve of the loudspeaker system, and matching the impedance curve by using the least square method to obtain the linear parameters of the loudspeaker system.

Concretely, the linear parameters of the loudspeaker system are estimated by matching the impedance curve, under the condition of large signal and without regard for the nonlinear of the system, the corresponding impedance characteristics can be obtained according to the formula (1) and the formula (2):

$$Z ( s ) = \frac{U ( s )}{I ( s )} = \frac{{sb}_{0}^{2}}{{m}_{t} {s}^{2} + {r}_{0} s + {k}_{0}} + {sL}_{e} + {R}_{e} \qquad ( 3 )$$

Using this method, the following linear parameters can be obtained: DC resistance Rₑ, voice coil inductance Lₑ, force factor linear item b₀, stiffness factor linear item k₀ and mechanical resistance linear item r₀. output of the linear parameters, at the same time, the linear parameters of real-time feedback to the lumped parameter model to update the model. Output the linear parameters, and at the same time, update the model through real time feedback of the linear parameters into the lumped parameter model.

In order to obtain the optimal linear parameters of the loudspeaker system, provide multiple pumping signals to the loudspeaker system within a period of time, and collect the voltage signal um and current signal iₘ of the loudspeaker system synchronously within this period of time, conduct crossover framing on uₘ and iₘ, conduct fast fourier transform (FFT) on the date of each frame, obtain frequency domain voltage signal U(ω) and frequency domain current signal I(ω), calculate the cross-power spectrum of U(ω) and I(ω) and the self-power spectrum of I(ω) respectively, conduct frame averaging on the above mentioned power spectrums, obtain the cross-power spectrum P_{UI}(ω) and the self-power spectrum P_{II}(ω), and then the actually measured impedance curve of the loudspeaker system, the calculation formula is as follows:

$${Z}_{m} ( ω ) = \frac{{P}_{UI} ( ω )}{{P}_{II} ( ω )} \qquad ( 4 )$$

According to the actually measured impedance curve Zₘ(ω) and the impedance characteristics formula (3) of the loudspeaker system, identify the linear parameters by using the least square method, the corresponding error evaluation formula is:

$$e = {\sum }_{i = 0}^{N - 1} {‖ {Z}_{p} ( {ω}_{i} ) - {Z}_{m} ( {ω}_{i} ) ‖}^{2} \qquad ( 5 )$$

Wherein, Zₚ(ωi) is the calculated impedance value based on the identification results, and N is the number of the frequency points of the impedance curve.

Calculate the errors e of the multiple pumping signals according to the formulas (3), (4) and (5), and take the minimum error value, then the linear parameters this minimum error value corresponds to are the optimal linear parameters.

S4: obtaining the nonlinear parameters of the loudspeaker system: inputting the measured current signal into the lumped parameter model of the loudspeaker system to calculate the estimated voltage signal uₚ[n] according to formula (1); comparing the estimated voltage signal uₚ[n] with the measured voltage signal um[n] mentioned above to calculate the voltage error signal eᵤ[n] between the two. The voltage error signal eᵤ[n] can be expressed as:

$${e}_{μ} [ n ] = {u}_{m} [ n ] - ( {R}_{e} {i}_{m} [ n ] + Bl ( x [ n ] ) v [ n ] + {L}_{e} \frac{di}{dt} ) \qquad ( 6 )$$

wherein, the calculation method for displacement X and velocity V can be expressed as:

$$\begin{matrix}x = {L}^{- 1} \{ \frac{1}{{m}_{t} {s}^{2} + {r}_{0} s + {k}_{0}} \} * \{ Bl ( x ) i - [ {k}_{t} ( x ) - {k}_{0} ] x - [ {R}_{m} ( v ) - {r}_{0} ] v \} & ( 7 ) \\ x = {L}^{- 1} \{ \frac{s}{{m}_{t} {s}^{2} + {r}_{0} s + {k}_{0}} \} * \{ Bl ( x ) i - [ {k}_{t} ( x ) - {k}_{0} ] x - [ {R}_{m} ( v ) - {r}_{0} ] v \} & ( 8 )\end{matrix}$$

wherein L⁻¹ represents inverse Laplace transformation, and “*” represents convolution.

The derivative of the current di/dt is calculated by using the “Simpson integration method”, and the corresponding transfer function can be expressed as:

$$H ( z ) = \frac{3 ( 1 - {z}^{- 2} )}{3.7321 {T}_{s} ( 1 + 0.5358 {z}^{- 1} + 0.0718 {z}^{- 2} )} \qquad ( 9 )$$

The error introduced by the linear parameters in the voltage error signal eᵤ[n] is so large that it conceals the nonlinear error, so by the adaptive estimation of the nonlinear parameters, the linear component in the voltage error signal eᵤ[n] needs to be removed so as to improve the accuracy of the estimated nonlinear parameters.

In this disclosure, the decoherence algorithm will be used to remove the linear component in the voltage error signal eᵤ[n] and to obtain the voltage error signal after decoherence eₙ[n], then the nonlinear parameters will be obtained by inputting the signal eₙ[n] into the adaptive iterative algorithm, and the nonlinear parameters will be updated continuously. The adaptive iterative algorithm can be expressed as:

$$\begin{matrix}{b}_{j} [ n + 1 ] = {b}_{j} [ n ] - {μ}_{{b}_{j}} {e}_{n} [ n ] \frac{\partial {e}_{u} [ n ]}{\partial {b}_{j}} & ( 10 ) \\ {k}_{j} [ n + 1 ] = {k}_{j} [ n ] - {μ}_{{k}_{j}} {e}_{n} [ n ] \frac{\partial {e}_{u} [ n ]}{\partial {k}_{j}} & ( 11 ) \\ {r}_{j} [ n + 1 ] = {r}_{j} [ n ] - {μ}_{{r}_{j}} {e}_{n} [ n ] \frac{\partial {e}_{u} [ n ]}{\partial {r}_{j}} & ( 12 )\end{matrix}$$

wherein, μ represents the step length of the iterative algorithm.

Substitute the bⱼ, kⱼ and rⱼ calculated with formulas (10), (11) and (12) and the values of displacement x and velocity v obtained by the discretization method into formula (13) to obtain the nonlinear parameters: force factor Bₗ(x), stiffness factor kₜ(x) and mechanical resistance Rₘ(v). Output the nonlinear parameters, and at the same time, update the model through the feedback of the nonlinear parameters to the lumped parameter model.

Concretely, when n pumping signals are provided into a loudspeaker system, the identification method this invention provides comprises n steps: wherein, the step i includes:

Providing the amplified No. i pumping signal to the loudspeaker system to be measured; measuring the No. i voltage signal and No. i current signal at both ends of the loudspeaker system synchronously; obtaining the No. i linear parameters of the loudspeaker system: calculating, according to the measured No. i voltage signal and measured No. i current signal, under the condition of large signal, the impedance curve of the loudspeaker system, and matching the impedance curve by using the least square method to obtain the No. i linear parameters of the loudspeaker system, and outputting the No. i linear parameters; obtaining the No. i nonlinear parameters of the loudspeaker system: inputting the measured No. i current signal mentioned above into the lumped parameter model of the loudspeaker system to calculate the estimated No. i voltage signal; comparing the No. i estimated voltage signal with the measured No. i voltage signal mentioned above to calculate the No. i voltage error signal between the two; conducting decoherence with the No. i voltage error signal to get rid of the linear component of the No. i voltage error signal, obtaining then, according to the No. i voltage error signal after decoherence, the No. i nonlinear parameters by using the adaptive iterative algorithm, and outputting the No. i nonlinear parameters; the step of estimating voltage signal with the lumped parameter model includes:

When i=1, the estimated voltage signal will be calculated according to the set value and by using the mentioned lumped parameter model;

When 1<i<n, input the i−1 linear parameters and i−1 nonlinear parameters calculated in the above steps in the i−1 pumping signal into the lumped parameter model to update the lumped parameter model, then calculate the estimated voltage signal corresponding to the No. i pumping signal with the updated lumped parameter model.

When the n steps are completed and the voltage error signal is at minimum, the nonlinear parameters corresponding to the minimum value of the output voltage error signal are the optimal nonlinear parameters of the loudspeaker system.

### Examples

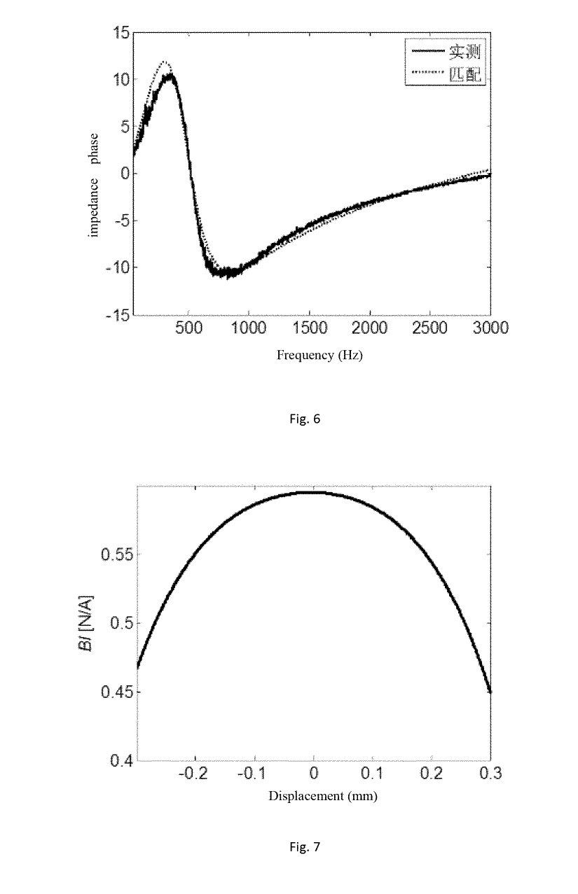

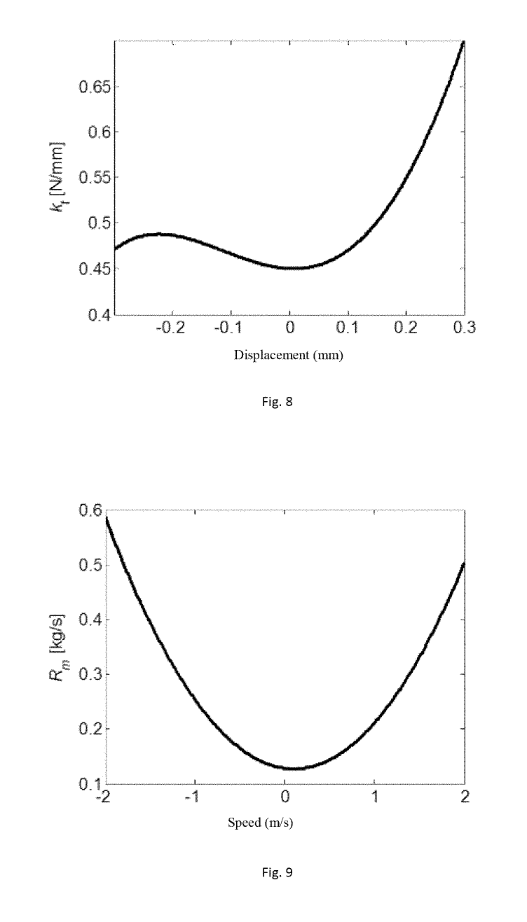

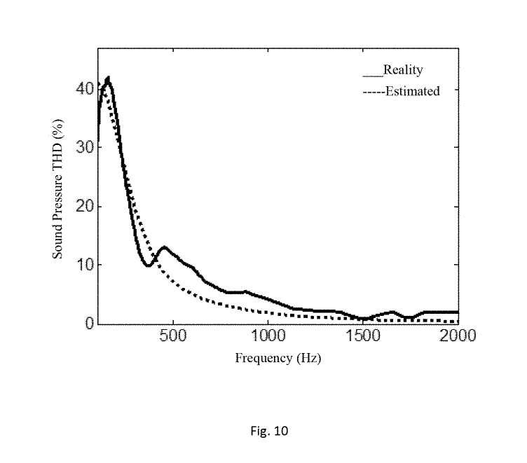

Referring to FIGS. 5-7, FIG. 5 shows the matching curves of actual measurement and impedance, FIG. 6 shows the curve of the estimated nonlinear parameters, including force factor Bl(x), stiffness factor kₜ(x) and mechanical resistance Rₘ(v), FIG. 7 shows the actually measured total harmonic distortion (THD) and the sound pressure THD curve simulated by using the estimated linear and nonlinear parameters when the effective voltage is 1V. The diaphragm of the loudspeaker system is 1.6 cm long, 0.9 cm wide. Input pink noise as a pumping signal into the loudspeaker system, with a pumping power of 0.15 W, measure the voltage signal and current signal at both ends of the loudspeaker system synchronously, and use the linear and nonlinear parameters of the loudspeaker system estimated with the identification method of a loudspeaker's nonlinear system provided by this invention, as shown in the following table.

TABLE 1
Linear and nonlinear parameters obtained by using the
identification method provided by the present disclosure

| Parameter name | Unit | Estimation result |
|---|---|---|
| Lₑ | H | 2.507 × 10⁻⁵ |
| Rₑ | Ω | 5.529 |
| b₀ | N/A | 0.5951 |
| b₁ | N/Am | −6.749 |
| b₂ | N/Am² | −9.180 × 10⁵ |
| b₃ | N/Am³ | −2.396 × 10⁸ |
| b₄ | N/Am⁴ | −6.798 × 10¹² |
| k₀ | N/m | 450.3 |
| k₁ | N/m² | −2.729 × 10⁴ |
| k₂ | N/m³ | 1.834 × 10⁹ |
| k₃ | N/m⁴ | 4.576 × 10¹² |
| k₄ | N/m⁵ | −3.596 × 10¹⁵ |
| r₀ | kg/s | 0.1280 |
| r₁ | kg/m | −0.0209 |
| r₂ | kg × s/m² | 0.1043 |

FIG. 7 shows that the actually measured sound pressure THD and the emulated sound pressure THD match well, and the parameters estimated with this method have a higher accuracy.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An identification method of nonlinear system of loudspeaker, comprising the following steps:
providing an amplified pumping signal to the loudspeaker to be measured;
measuring a voltage signal and a current signal at both ends of the loudspeaker synchronously;
obtaining linear parameters of the loudspeaker system: calculating, according to the measured voltage signal and measured current signal, under the condition of large signal, an impedance curve of the loudspeaker system, and matching the impedance curve by using the least square method to obtain the linear parameters of the loudspeaker system;
obtaining the nonlinear parameters of the loudspeaker system: inputting the measured current signal into a lumped parameter model of the loudspeaker system to calculate the estimated voltage signal;
comparing the estimated voltage signal with the measured voltage signal mentioned above to calculate a voltage error signal between the two; conducting decoherence with the voltage error signal to get rid of a linear component of the voltage error signal, obtaining then, according to the voltage error signal after decoherence, the nonlinear parameters by using the adaptive iterative algorithm.

2. The identification method of nonlinear system of loudspeaker as described in claim 1, wherein the linear parameters include a DC resistance Rₑ, a voice coil inductance Lₑ, a force factor linear term b₀, a stiffness factor linear term k₀ and a mechanical resistance linear term r₀; and the nonlinear parameters include a force factor Bl(x), a stiffness factor kₜ(x) and a mechanical resistance Rₘ(v), wherein:
$$Bl ( x ) = {\sum }_{j = 0}^{N} {b}_{j} {x}^{j}$$
$${k}_{t} ( x ) = {\sum }_{j = 0}^{N} {k}_{j} {x}^{j}$$
$${R}_{m} ( v ) = {\sum }_{j = 1}^{N} {r}_{j} {v}^{j}$$
where, x and v represent a displacement and velocity of a diaphragm of the loudspeaker, respectively.

3. The identification method of nonlinear system of loudspeaker as described in claim 2, further including a step of providing a real time feedback of the linear parameters and nonlinear parameters into the lumped parameter model to update the mentioned lumped parameter model.

4. The identification method of nonlinear system of loudspeaker as described in claim 3, wherein, in the step of obtaining the linear parameters, the impedance characteristic of the impedance curve is expressed as:
$$Z ( s ) = \frac{U ( s )}{I ( s )} = \frac{{sb}_{0}^{2}}{{m}_{t} {s}^{2} + {r}_{0} s + {k}_{0}} + {sL}_{e} + {R}_{e}$$
and the linear parameters are obtained by matching the impedance curve with the least square method.

5. The identification method of nonlinear system of loudspeaker as described claim 4, wherein, in the step of obtaining the nonlinear parameters, the voltage model corresponding to the mentioned lumped parameter model is expressed as:
$${u}_{e} = {R}_{e} i + Bl ( x ) v + {L}_{e} \frac{di}{dt} ;$$
the estimated voltage signal is expressed as:
$${u}_{p} [ n ] = {R}_{e} {i}_{m} [ n ] + B 1 ( x [ n ] ) v [ n ] + {L}_{δ} \frac{di}{dt} ;$$
where, uₚ[n] represents the estimated voltage signal, iₘ [n]represents the measured current signal, x and v, respectively, represent the displacement and velocity of the diaphragm of the loudspeaker.

6. The identification method of nonlinear system of loudspeaker as described in claim 5, further including a Simpson integration method used to calculate the di/dt, wherein the transfer function corresponding to the integration method is expressed as:
$$H ( z ) = \frac{3 ( 1 - {z}^{- 2} )}{3.7321 {T}_{s} ( 1 + 0.5358 {z}^{- 1} + 0.0718 {z}^{- 2} )} .$$

7. The identification method of nonlinear system of loudspeaker as described in claim 6, wherein, in the step of obtaining the linear parameters, the voltage error signal is expressed as:
eᵤ[n]=uₘ[n]−uₚ[n]
where uₙ[n] represents the measured voltage signal.

8. The identification method of nonlinear system of loudspeaker as described in claim 7, wherein, in the step of obtaining the nonlinear parameters, the mentioned adaptive iterative algorithm is expressed as:
$$\begin{matrix}{b}_{j} [ n + 1 ] = {b}_{j} [ n ] - {μ}_{{b}_{j}} {e}_{n} [ n ] \frac{\partial {e}_{u} [ n ]}{\partial {b}_{j}} \\ {k}_{j} [ n + 1 ] = {k}_{j} [ n ] - {μ}_{{k}_{j}} {e}_{n} [ n ] \frac{\partial {e}_{u} [ n ]}{\partial {k}_{j}} \\ {r}_{j} [ n + 1 ] = {r}_{j} [ n ] - {μ}_{{r}_{j}} {e}_{n} [ n ] \frac{\partial {e}_{u} [ n ]}{\partial {r}_{j}}\end{matrix}$$
where μ represents the step length of the mentioned adaptive iterative algorithm, the value of μ is set by initialization.

9. An identification method of nonlinear system of loudspeaker comprising n steps of identification of the nonlinear system of the loudspeaker:
wherein, a No. I step comprising:
providing an amplified No. i pumping signal to the loudspeaker to be measured;
measuring the No. i voltage signal and current signal at both ends of the loudspeaker system synchronously;
obtaining the No. i linear parameters of the loudspeaker:
calculating, according to the measured No. i voltage signal and measured No. i current signal, under the condition of large signal, the impedance curve of the loudspeaker system, and matching the impedance curve by using the least square method to obtain the No. i linear parameters of the loudspeaker, and outputting the No. i linear parameters;
obtaining the No. i nonlinear parameters of the loudspeaker: inputting the measured No. i current signal into the lumped parameter model of the loudspeaker system to calculate the estimated No. i voltage signal;
comparing the No. i estimated voltage signal with the measured No. i voltage signal mentioned above to calculate the No. i voltage error signal between the two;
conducting decoherence with the No. i voltage error signal to get rid of the linear component of the No. i voltage error signal, obtaining then, according to the No. i voltage error signal after decoherence, the No. i nonlinear parameters by using the adaptive iterative algorithm, and outputting the No. i nonlinear parameters;
wherein the step of estimating voltage signal with the lumped parameter model includes that:
when i=1, the estimated voltage signal will be calculated according to the set value and by using the mentioned lumped parameter model;
when 1<i<n, input the i−1 linear parameters and i−1 nonlinear parameters calculated in the i−1 pumping signal into the lumped parameter model to update the lumped parameter model, then calculate the estimated voltage signal corresponding to the No. i pumping signal with the updated lumped parameter model.

10. The identification method of nonlinear system of loudspeaker as described in claim 9, further including a step of:
when the voltage error signal is minimum, the nonlinear parameter corresponding to the minimum value of the voltage error signal is output.
